(19) United States
(12) Patent Application Publication
(10) Pub. No.: US 2025/0235049 A1
(43) Pub. Date: Jul. 24, 2025

(54) ELECTRIC GRINDER

(71) Applicant: NINGBO KAIDELI ELECTRIC CO., LTD, Ningbo (CN)

(72) Inventor: Songbiao Wang, Ningbo (CN)

(21) Appl. No.: 18/434,878

(22) Filed: Feb. 7, 2024

(30) Foreign Application Priority Data
Jan. 24, 2024 (CN) 202420181586.5

(51) Int. Cl. A47J 42/46; A47J 42/08; A47J 42/10

(52) U.S. Cl. CPC A47J 42/46; A47J 42/08; A47J 42/10

(57) ABSTRACT

An electric grinder includes a housing, two grinding assemblies and a driving device, where the housing is internally provided with two independent material storage cavities, and each of the material storage cavities is provided with a feeding port and a discharging port; the two grinding assemblies are respectively and correspondingly disposed at the discharging ports, and disk type ratchet wheels are respectively disposed on driving shafts of the grinding assemblies, and the two disk type ratchet wheels face opposite directions; and the driving device includes a driving unit and a transmission mechanism, an output end of the driving unit transmits torque to the driving shafts of the grinding assemblies through the transmission mechanism, and the driving unit respectively and singly drives one of the grinding assemblies to singly work through the transmission mechanism when positively rotating or reversely rotating.

### CROSS REFERENCE TO RELATED APPLICATIONS

The present application claims the benefit of Chinese Patent Application No. 202420181586.5 filed on Jan. 24, 2024, the contents of which are incorporated herein by reference in their entirety.

### TECHNICAL FIELD

The present disclosure relates to the technical field of a grinder, and in particular to an electric grinder.

### BACKGROUND

A pepper grinder is a kitchen tool for grinding pepper corns. The pepper grinder generally consists of a grinding mechanism and a container for accommodating pepper corns. The grinding mechanism generally consists of a fixed female grinding core and a rotatable male grinding core. A working principle of the pepper grinder is based on friction between the female grinding core and the male grinding core. When a user rotates the male grinding core, the pepper corns may be ground into fine particles through the friction between the female grinding core and the male grinding core. The grinding fineness may be controlled by the user through adjusting the rotating speed and intensity of the male grinding core.

A traditional grinder may be used for grinding only one kind of particulate materials. Odor tainting may be easily caused if a grinding assembly is not cleaned when different particulate materials are ground. Therefore, there is a vertical double-material-cabin and double-head grinder on the market. A cylinder is disposed in a middle section of a cylindrical grinder, the two ends are symmetrically and sequentially provided with the same parts with the same numbers as follows from the center to two ends: convex periphery short cylinders with square through holes in the centers thereof and a disc type fastener with a notch periphery, all fastened to the cylinder by screws, and a square aluminum rod which is provided with discontinuous screw threads and consists of a square shaft and a compressed spring, sequentially passes through a material cabin bottom, an outer sheath, a model fixing frame, a plastic press sheet, a ceramic grinding ring and a grinding core, and is screwed on an end portion of the square aluminum rod through an adjusting knob.

However, manual driving is still needed in the above solution, and the use is inconvenient.

### SUMMARY

The present disclosure is intended to resolve one of technical problems in the background to some extent. Therefore, the present disclosure provides an electric grinder.

The present disclosure adopts the technical solution to provide an electric grinder including: a housing, two grinding assemblies and a driving device, where
the housing is internally provided with two independent material storage cavities, and each of the material storage cavities is provided with a feeding port and a discharging port;
the two grinding assemblies are respectively and correspondingly disposed at the discharging ports, and disk type ratchet wheels are respectively disposed on driving shafts of the grinding assemblies, and the two disk type ratchet wheels face opposite directions; and
the driving device includes a driving unit and a transmission mechanism, an output end of the driving unit transmits torque to the driving shafts of the grinding assemblies through the transmission mechanism, and the driving unit respectively and singly drives one of the grinding assemblies to singly work through the transmission mechanism when positively rotating or reversely rotating.

By adopting the structure, the two material storage cavities respectively correspond to two kinds of particulate materials, or respectively correspond to the same kind of particulate materials with different particulate fineness. The driving device is configured to drive any one of the two grinding assemblies to singly work. By changing the rotating direction of the driving unit, working objects of the grinding assemblies are respectively switched to achieve an objective that the electric grinder selectively processes one or an other kind of particulate materials. Compared with the prior art, the electric grinder has advantages that structure is more compact, quantity of components is optimized, and two kinds of particulate materials can be ground without need of changing or cleaning a grinder.

According to an embodiment of the present disclosure, the transmission mechanism includes a driving gear connected with an output shaft of the driving unit and two driven ratchet-gear wheels disposed in a manner of being coaxial with the driving shafts, outer teeth of the two driven ratchet-gear wheels are respectively engaged with the driving gear, an axial end of each of the driven ratchet-gear wheels is engaged with the corresponding disk type ratchet wheel, the driving unit drives the driving gear to positively rotate or reversely rotate, and one of the grinding assemblies is driven to singly work sequentially through power transmission of the driven ratchet-gear wheels and the disk type ratchet wheels. Oblique teeth on the two disk type ratchet wheels face opposite directions. Correspondingly, oblique teeth at an axial end of the two driven ratchet-gear wheels engaged with the disk type ratchet wheels face opposite directions. Therefore, when the driving unit drives the driving gear to rotate, one of the driven ratchet-gear wheels is engaged with the corresponding disk type ratchet wheel, and the other driven ratchet-gear wheel is disengaged from the corresponding disk type ratchet wheel, so that the driving unit can only drive the driving shaft of one grinding assembly to rotate, and the driving shaft of the other grinding assembly does not rotate. Similarly, the driving unit conforms to a vise versa principle. The technical objective that the electric grinder selectively processes one or the other kind of particulate materials is finally achieved.

According to an embodiment of the present disclosure, a decelerating unit is disposed between the output end of the driving unit and the driving gear. The decelerating unit may decelerate a rotating speed of the output end of the driving unit and improve an output torque.

According to an embodiment of the present disclosure, each of the driving shafts is provided with a polished shaft portion, and each of the driven ratchet-gear wheels is installed on the corresponding polished shaft portion in an axially movable manner. That is, the driven ratchet-gear wheels are provided with shaft holes in clearance fit with the polished shaft portions.

According to an embodiment of the present disclosure, the driven ratchet-gear wheels are elastically installed on each of the driving shafts, and the driven ratchet-gear wheels have the motion tendency of keeping engagement with the corresponding disk type ratchet wheel.

According to an embodiment of the present disclosure, the electric grinder further includes an installing frame, and the driving unit and the transmission mechanism are installed on the installing frame.

According to an embodiment of the present disclosure, the electric grinder further includes a protection cover, and the protection cover is combined with the installing frame to form a sealed space for installing the transmission mechanism.

According to an embodiment of the present disclosure, a shaft support frame and two positioning rings are fixedly installed in the housing, the driving shafts respectively pass through the shaft support frame and the positioning rings, and the positioning rings are able to rotate relative to the shaft support frame.

According to an embodiment of the present disclosure, each of the grinding assemblies includes a female grinding core and a male grinding core, the female grinding core is fixedly installed on the housing, and the male grinding core is disposed on the driving shaft.

According to an embodiment of the present disclosure, each of the grinding assemblies further includes an adjusting knob connected with the corresponding driving shaft through screw threads, and the adjusting knob is configured to adjust an axial position of the male grinding core on the corresponding driving shaft.

### BRIEF DESCRIPTION OF THE DRAWINGS

In order to describe the technical solution of embodiments of the present disclosure or in the prior art more clearly, accompanying drawings to be used in embodiments or in the prior art are briefly introduced. Obviously, the accompanying drawings described hereafter are only some embodiments of the present disclosure. For a person of ordinary skill in the art, other drawings can also be obtained according to these drawings without any inventive efforts.

FIG. 1 is a three-dimensional diagram of an electric grinder in an embodiment of the present disclosure.

FIG. 2 is a schematic structural diagram of an electric grinder in an embodiment of the present disclosure.

FIG. 3 is a sectional view of an electric grinder in an embodiment of the present disclosure.

FIG. 4 is a partial structural diagram of an electric grinder in an embodiment of the present disclosure.

FIG. 5 is a structural diagram of an electric grinder after protection cover removal in FIG. 4.

FIG. 6 is a schematic structural diagram when a driving unit positively rotates in an embodiment of the present disclosure.

FIG. 7 is a schematic structural diagram when a driving unit reversely rotates in an embodiment of the present disclosure.

FIG. 8 is a partial sectional view of an electric grinder in an embodiment of the present disclosure.

FIG. 9 is a schematic diagram of connection of a driving shaft in an embodiment of the present disclosure.

FIG. 10 is an exploded view of a driving shaft in an embodiment of the present disclosure.

FIG. 11 is a schematic structural diagram of a female grinding core in an embodiment of the present disclosure.

In the figures,
1 denotes a housing, 2 denotes a top cover, 3 denotes a first material storage cavity, 4 denotes a battery cover, 5 denotes a bottom cover, 6 denotes a battery unit, 7 denotes a driving unit, 8 denotes a positioning ring, 9 denotes a shaft support frame, 10 denotes a driving shaft, 11 denotes an installing frame, 12 denotes a protection cover, 13 denotes a driving gear, 14 denotes a driven ratchet-gear wheel, 15 denotes a disk type ratchet wheel, 16 denotes a female grinding core, 17 denotes a male grinding core, 18 denotes an adjusting knob, 19 denotes a second material storage cavity,
10a denotes a polished shaft portion, 10b denotes a threaded portion, and
15a denotes a ratchet wheel portion.

### DETAILED DESCRIPTION

Embodiments of the present disclosure are described in detail below, and examples of the embodiments are shown in accompanying drawings, where the same or similar elements or the elements having same or similar functions are denoted by the same or similar reference numerals throughout the description. The following embodiments described with reference to the accompanying drawings are exemplary, and are merely intended to explain the present disclosure but cannot be construed as a limitation to the present disclosure.

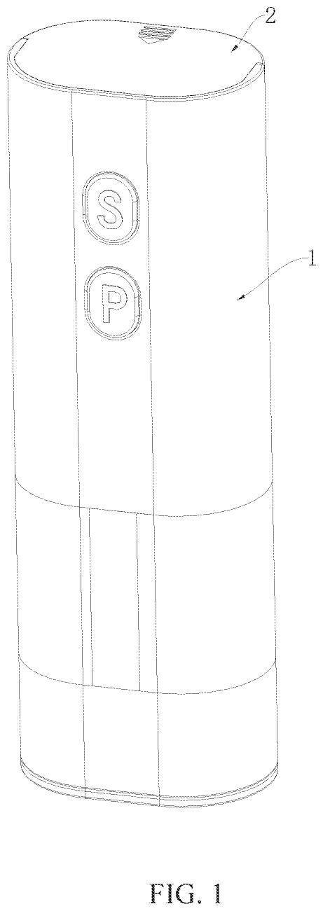

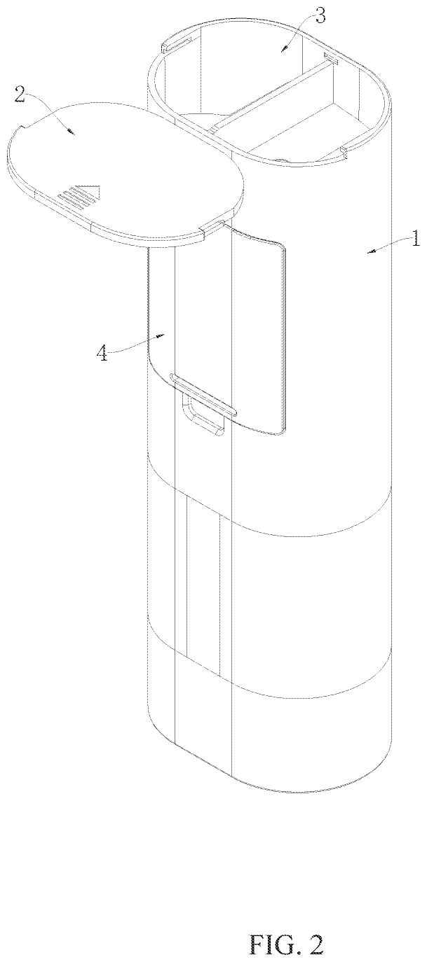

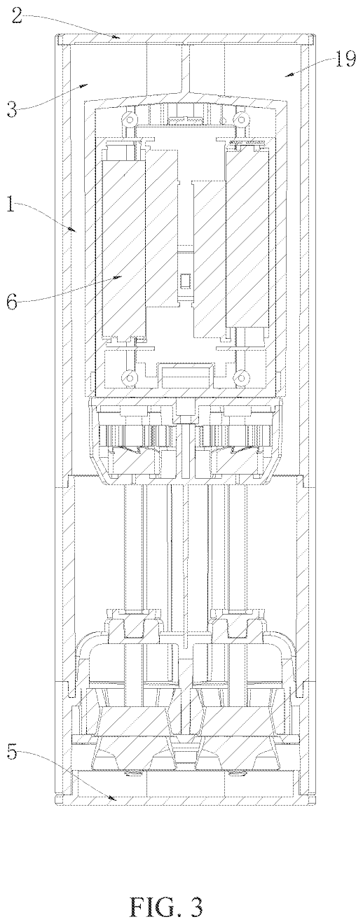

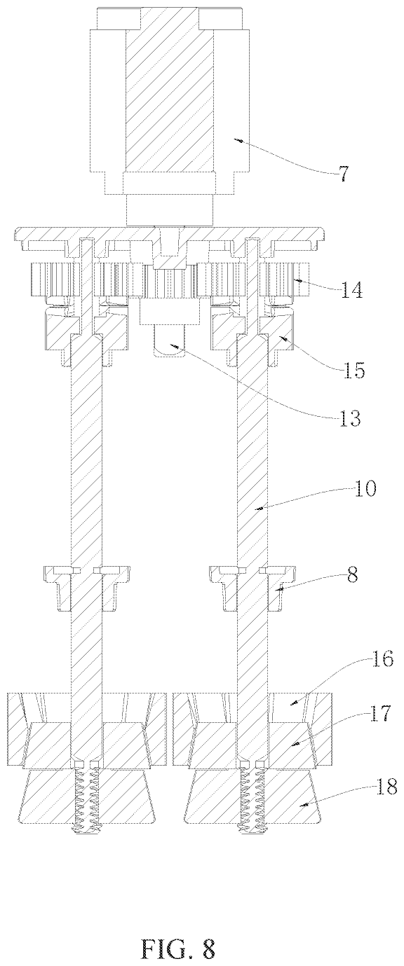

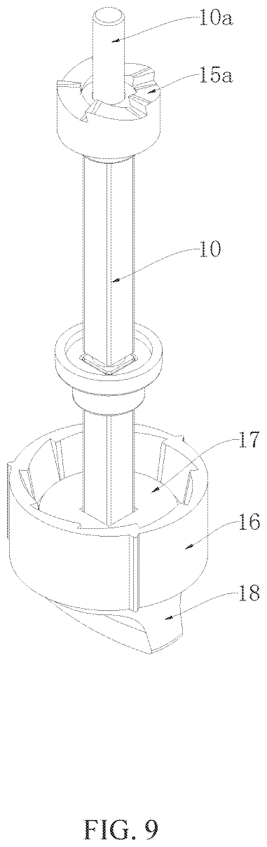

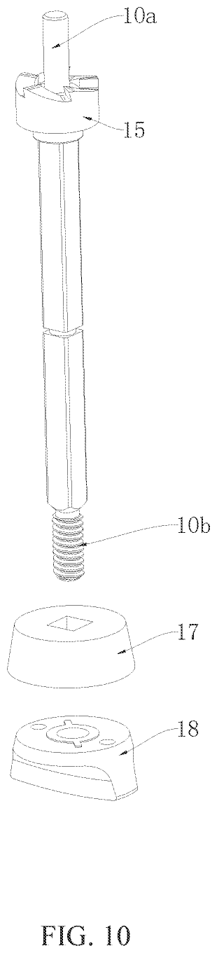

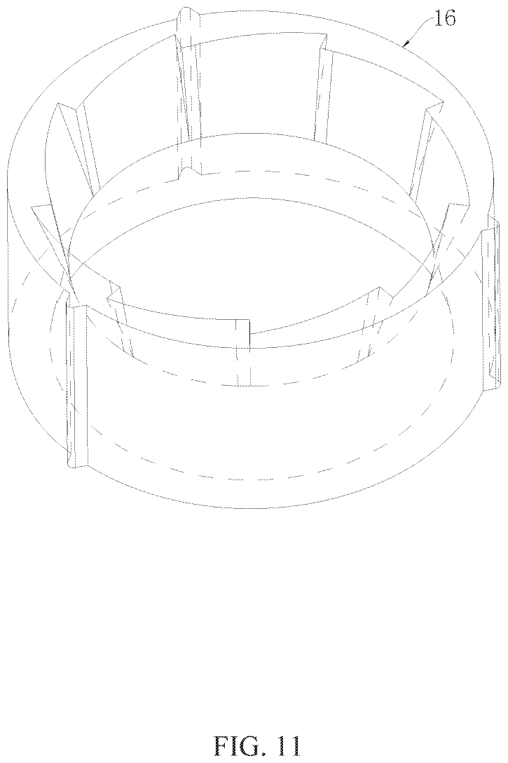

As shown in FIG. 1 to FIG. 11, the present embodiment discloses an electric grinder, including a housing 1, two grinding assemblies and a driving device.

The housing 1 is internally provided with two independent material storage cavities, and each of the material storage cavities is provided with a feeding port and a discharging port.

The two grinding assemblies are respectively and correspondingly disposed at the discharging ports, and disk type ratchet wheels 15 are respectively disposed on driving shafts 10 of the grinding assemblies, and the two disk type ratchet wheels 15 face opposite directions.

The driving device includes a driving unit 7 and a transmission mechanism, an output end of the driving unit 7 transmits torque to the driving shafts 10 of the grinding assemblies through the transmission mechanism, and the driving unit 7 respectively and singly drives one of the grinding assemblies to singly work through the transmission mechanism when positively rotating or reversely rotating.

As shown in FIG. 1 to FIG. 3, a first material storage cavity 3 and a second material storage cavity 19 are formed in the housing 1 of the present embodiment, and are respectively configured to accommodate different seasoning particulate materials. In other embodiments, the first material storage cavity 3 and the second material storage cavity 19 are respectively configured to accommodate the same kind of seasoning particulate materials. An upper end of the housing 1 is detachably connected with a top cover 2, and a lower end of the housing is detachably connected with a bottom cover 5. The top cover 2 is configured to seal feeding ports at upper ends of the first material storage cavity 3 and the second material storage cavity 19. Discharging ports at bottoms of the first material storage cavity 3 and the second material storage cavity 19 are positioned in the housing 1. The bottom cover 5 has an effect of avoiding outward exposure of the discharging ports.

Further, two buttons are disposed at a front side of the housing 1 in the present embodiment. The rotating direction of the driving unit 7 may be adjusted by pressing different buttons. A battery cover 4 is disposed at a back side of the housing 1, a battery holder is correspondingly disposed inside the housing 1. Battery units 6 are disposed in the battery holder, and the battery units 6 are configured to supply electricity to electrical components such as the driving unit 7.

Specifically, the transmission mechanism includes a driving gear 13 connected with an output shaft of the driving unit 7 and two driven ratchet-gear wheels 14 disposed in a manner of being coaxial with the driving shafts 10, outer teeth of the two driven ratchet-gear wheels 14 are respectively engaged with the driving gear 13, an axial end of each of the driven ratchet-gear wheels 14 is engaged with the corresponding disk type ratchet wheel 15, the driving unit 7 drives the driving gear 13 to positively rotate or reversely rotate, and one of the grinding assemblies is driven to singly work sequentially through power transmission of the driven ratchet-gear wheels 14 and the disk type ratchet wheels 15.

Further, in the present embodiment, an installing frame 11 is disposed in the housing 1, and upper ends of the driving shafts 10 are rotatably connected with the installing frame 11. The driving unit 7 uses a motor, and the motor is in driving installation on an upper portion of the installing frame 11. A decelerating unit (not shown in the figures) is disposed between the output end of the driving unit 7 and the driving gear 13. Two driven ratchet-gear wheels 14 in parallel arrangement are installed at a lower portion of the installing frame 11, an upper end of each of the driving shafts 10 is provided with a polished shaft portion 10a, and each of the driven ratchet-gear wheels 14 is installed on the corresponding polished shaft portion 10a in an axially movable manner.

Further, in the present embodiment, a spring is disposed between each of the driven ratchet-gear wheels 14 and the installing frame 11, and the spring has an effect of enabling the driven ratchet-gear wheel 14 to have the elasticity tendency of keeping engagement with the corresponding disk type ratchet wheel 15.

Furthermore, in the present embodiment, straight teeth engaged with the driving gear 13 are disposed on an outer periphery of each of the driven ratchet-gear wheels 14, an upper end surface of each of the disk type ratchet wheels 15 is provided with a ratchet wheel portion 15a, and a lower end surface of each of the driven ratchet-gear wheels 14 is provided with oblique teeth engaged with the ratchet wheel portion 15a on the corresponding disk type ratchet wheel 15.

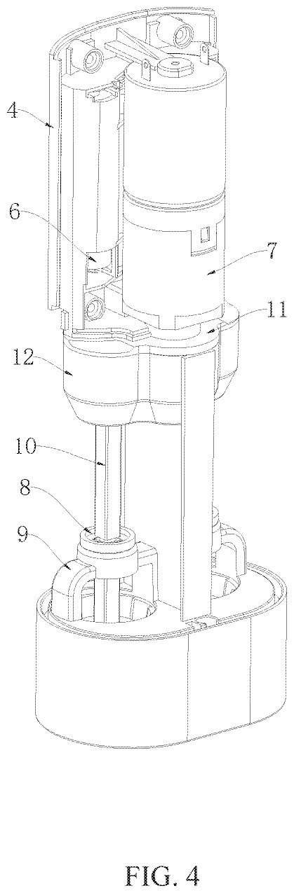

Specifically, as shown in FIG. 4 to FIG. 6, the electric grinder in the present embodiment further includes an installing frame 11 and a protection cover 12. The driving unit 7 and the transmission mechanism are installed on the installing frame 11. The protection cover 12 is combined with the installing frame 11 to form a sealed space for installing the transmission mechanism.

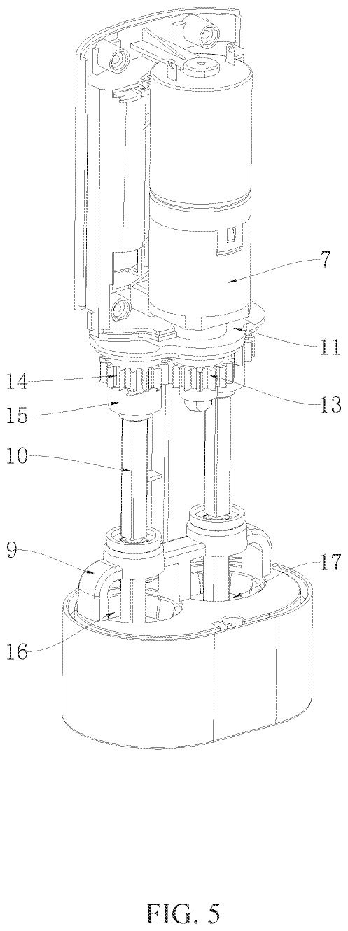

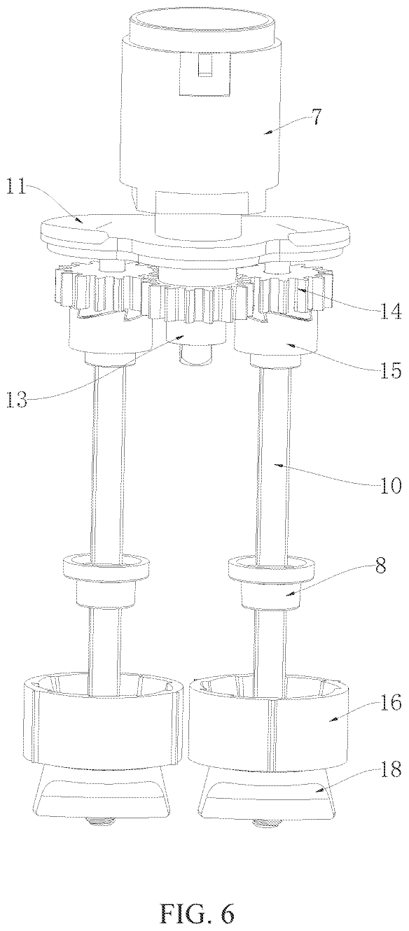

Specifically, as shown in FIG. 5 to FIG. 6, in the present embodiment, a shaft support frame 9 and two positioning rings 8 are fixedly installed in the housing 1, the driving shafts 10 respectively pass through the shaft support frame 9 and the positioning rings 8, and the positioning rings 8 are able to rotate relative to the shaft support frame 9. The positioning rings 8 and the driving shafts 10 are in key joint, and the positioning rings can rotate relative to the shaft support frame 9 along with the rotation of the driving shafts 10. The positioning rings 8 are configured to position axial positions of the driving shafts 10 to avoid influence on the grinding quality caused by influence on the position of the male grinding cores 17 in the grinding assemblies due to the axial deviation of the driving shafts 10. Additionally, the positioning rings 8 are configured to effectively ensure the coaxality of the two driving shafts 10, so that the driving shafts are more stable in a working process.

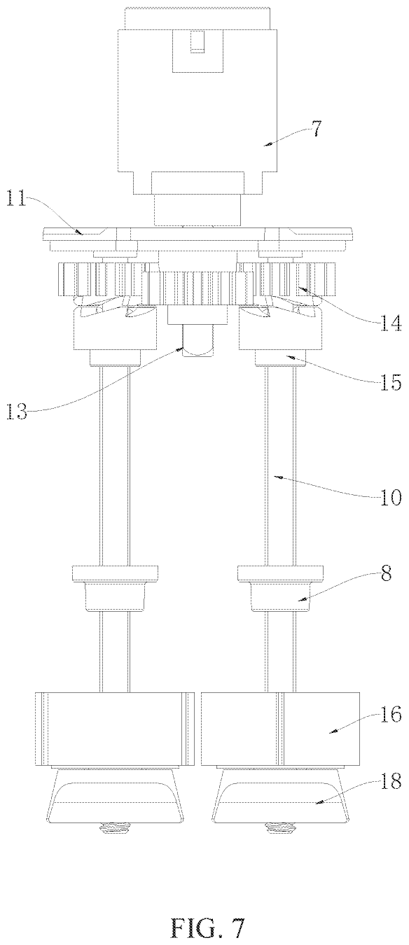

Specifically, as shown in FIG. 7 to FIG. 11, each of the grinding assemblies in the present embodiment includes a female grinding core 16 and a male grinding core 17, the female grinding core 16 is fixedly installed on the housing 1, and the male grinding core 17 is disposed on the driving shaft 10. Each of the grinding assemblies further includes an adjusting knob 18 connected with the corresponding driving shaft 10 through screw threads, and the adjusting knob 18 is configured to adjust the axial position of the male grinding core 17 on the corresponding driving shaft 10.

Further, a threaded portion 10b is disposed at a lower end of each of the driving shafts 10, the adjusting knob 18 is provided with internal screw threads connected with the threaded portion 10b through screw threads, and the axial position of the adjusting knob 18 on the driving shaft 10 is changed by rotating the adjusting knob 18. The male grinding core 17 and the driving shaft 10 are in key point, and are supported by the adjusting knob 18 under the gravity influence. If the axial position of the adjusting knob 18 on the driving shaft 10 changes, the position of the male grinding core 17 changes correspondingly. A gap between a grinding surface of an outer periphery of the male grinding core 17 and a grinding surface of an inner periphery of the female grinding core 16 changes correspondingly, and the grinding fineness of the grinding assemblies is further changed.

In the description of the present disclosure, it should be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial”, “radial”, and “circumferential” are based on orientation or position relationships shown in the accompanying drawings, and are used only for ease and brevity of illustration and description of the present disclosure, rather than indicating or implying that the mentioned apparatus or component must have a particular orientation or must be constructed and operated in a particular orientation. Therefore, such terms should not be construed as limiting of the present disclosure.

In addition, the terms such as “first” and “second” are used only for the purpose of description, and should not be understood as indicating or implying the relative importance or implicitly specifying the quantity of the indicated technical features. Therefore, a feature restricted by “first” or “second” may explicitly indicate or implicitly include at least one of such features. In the descriptions of the present disclosure, unless explicitly specified, “multiple” means at least two, for example, two or three.

In the present disclosure, it should be noted that unless otherwise explicitly specified and limited, the terms “install”, “connect”, “connection”, and “fix” should be understood in a broad sense. For example, a connection may be a fixed connection, a detachable connection, or an integral connection; or the connection may be a mechanical connection or an electrical connection or may communicate with each other; or the connection may be a direct connection, an indirect connection through an intermediary, or internal communication between two elements or mutual action relationship between two elements, unless otherwise specified explicitly. A person of ordinary skill in the art can understand specific meanings of the terms in the present disclosure according to specific situations.

In the present disclosure, unless otherwise explicitly specified or defined, the first feature being located “above” or “below” the second feature may be the first feature being in a direct contact with the second feature, or the first feature being in an indirect contact with the second feature through an intermediary. In addition, that the first feature is “above”, “over”, or “on” the second feature may indicate that the first feature is directly above or obliquely above the second feature, or may merely indicate that the horizontal position of the first feature is higher than that of the second feature. That the first feature is “below”, “under”, and “beneath” the second feature may be that the first feature is right below the second feature or at an inclined bottom of the second feature, or may merely indicate that the horizontal position of the first feature is lower than that of the second feature.

In the descriptions of this specification, a description of a reference term such as “an embodiment”, “some embodiments”, “an example”, “a specific example”, or “some examples” means that a specific feature, structure, material, or characteristic that is described with reference to the embodiment or the example is included in at least one embodiment or example of the present disclosure. In this specification, schematic descriptions of the foregoing terms are not necessarily directed at the same embodiment or example. Besides, the specific features, the structures, the materials or the characteristics that are described may be combined in proper manners in any one or more embodiments or examples. In addition, a person skilled in the art may integrate or combine different embodiments or examples described in the specification and features of the different embodiments or examples as long as they are not contradictory to each other.

Although the embodiments of the present disclosure have been shown and described above, it can be understood that, the foregoing embodiments are exemplary and should not be understood as limitation to the present disclosure. A person of ordinary skill in the art can make changes, modifications, or variations to the foregoing embodiments within the scope of the present disclosure.

What is claimed is:

1. An electric grinder, comprising:
a housing, internally provided with two independent material storage cavities, and each of the material storage cavities being provided with a feeding port and a discharging port;
two grinding assemblies, respectively and correspondingly disposed at the discharging ports, and disk type ratchet wheels being respectively disposed on driving shafts of the grinding assemblies, and the two disk type ratchet wheels facing opposite directions; and
a driving device, comprising a driving unit and a transmission mechanism, an output end of the driving unit transmitting torque to the driving shafts of the grinding assemblies through the transmission mechanism, and the driving unit respectively and singly driving one of the grinding assemblies to singly work through the transmission mechanism when positively rotating or reversely rotating.

2. The electric grinder according to claim 1, wherein the transmission mechanism comprises a driving gear connected with an output shaft of the driving unit and two driven ratchet-gear wheels disposed in a manner of being coaxial with the driving shafts, outer teeth of the two driven ratchet-gear wheels are respectively engaged with the driving gear, an axial end of each of the driven ratchet-gear wheels is engaged with the corresponding disk type ratchet wheel, the driving unit drives the driving gear to positively rotate or reversely rotate, and one of the grinding assemblies is driven to singly work sequentially through power transmission of the driven ratchet-gear wheels and the disk type ratchet wheels.

3. The electric grinder according to claim 2, wherein a decelerating unit is disposed between the output end of the driving unit and the driving gear.

4. The electric grinder according to claim 2, wherein each of the driving shafts is provided with a polished shaft portion, and each of the driven ratchet-gear wheels is installed on the corresponding polished shaft portion in an axially movable manner.

5. The electric grinder according to claim 2, wherein the driven ratchet-gear wheels are elastically installed on each of the driving shafts, and the driven ratchet-gear wheels have a motion tendency of keeping engagement with the corresponding disk type ratchet wheel.

6. The electric grinder according to claim 1, further comprising an installing frame, wherein the driving unit and the transmission mechanism are installed on the installing frame.

7. The electric grinder according to claim 6, further comprising a protection cover, wherein the protection cover is combined with the installing frame to form a sealed space for installing the transmission mechanism.

8. The electric grinder according to claim 1, wherein a shaft support frame and two positioning rings are fixedly installed in the housing, the driving shafts respectively pass through the shaft support frame and the positioning rings, and the positioning rings are able to rotate relative to the shaft support frame.

9. The electric grinder according to claim 1, wherein each of the grinding assemblies comprises a female grinding core and a male grinding core, the female grinding core is fixedly installed on the housing, and the male grinding core is disposed on the driving shaft.

10. The electric grinder according to claim 9, wherein each of the grinding assemblies further comprises an adjusting knob connected with the corresponding driving shaft through screw threads, and the adjusting knob is configured to adjust an axial position of the male grinding core on the corresponding driving shaft.
